(19) United States
(12) Patent Application Publication
(10) Pub. No.: US 2007/0100054 A1
(43) Pub. Date: May 3, 2007

(54) Process for producing blow molded product

(75) Inventors: Hirotaka Uosaki, Ichihara-shi (JP); Kuniaki Kawabe, Ichihara-shi (JP); Motoyasu Yasui, Chiba-shi (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc., Sodegaura-shi (JP)

(21) Appl. No.: 11/543,165

(22) Filed: Oct. 5, 2006

Related U.S. Application Data
(60) Provisional application No. 60/738,583, filed on Nov. 22, 2005.

(30) Foreign Application Priority Data
Oct. 7, 2005 (JP) 2005-295664

(51) Int. Cl. C08L 91/08

(52) U.S. Cl. 524/487

(57) ABSTRACT

The present invention provides a process for improving the moldability in the blow molding and efficiently producing a molded product, without deterioration of the physical properties of the molded product. The process comprises melting a mixture of a thermoplastic resin, and a polyolefin wax which has a number-average molecular weight (Mn) in terms of polyethylene, in the range of 200 to 5,000, and a crystallization temperature, as measured by a differential scanning calorimetry (DSC) in the range of 65 to 120° C., and then subjecting the mixture to blow molding.

### BACKGROUND OF THE INVENTION

1. Field of the Invention

The present invention relates to a process for producing a molded product, and more specifically to a process for producing a molded product, comprising melting a mixture of a thermoplastic resin and a polyolefin wax and then subjecting the mixture to blow molding.

2. Description of the Related Art

Blow molding is one of the processes for preparing a molded product from resin materials, and has been used in the preparation of containers such as bottles, and tanks, architectural materials such as external walls, automobile parts such as automobile exterior parts, industrial machinery parts, electrical and electronic parts and the like.

Particularly, in recent years, there is a need of a process for improving the productivity of the blow molding without deterioration of various physical properties of the molded article.

For example, there have been investigations on a molding machine for blow molding, or a process for improving the productivity of the molding by modifying the molding conditions (see, for example, JP-A No. 11-254512, and Pamphlet of W097/45246).

However, there is still a need of a process for improving the productivity of the molding without deterioration of various physical properties of the molded article, even with no use of special molding machines or molding conditions, and the conventional processes need further improvement on the productivity.

### SUMMARY OF THE INVENTION

It is an object of the present invention to provide a process for improving the moldability in the blow molding and efficiently producing a molded product, without deterioration of the physical properties of the molded product.

The present inventors have earnestly studied to overcome the above-described problems, and as a result, they have found that improvement on the productivity of the blow molding and efficient production of a molded product can be accomplished by melting a mixture of a thermoplastic resin and a specific wax, and then subjecting the mixture to blow molding, thus leading to completion of the present invention.

Specifically, the process for producing an blow molded article according to the present invention, is characterized in that it comprises melting a mixture of a thermoplastic resin (A) and a polyolefin wax (B) which has a number-average molecular weight (Mn) in terms of polystyrene, as measured by gel permeation chromatography, in the range of 400 to 5,000, and a crystallization temperature, as measured by a differential scanning calorimetry (DSC) under the condition of a temperature lowering rate of 2° C./min., in the range of 65 to 120° C., and then subjecting the mixture to blow molding.

Also, the process for producing an blow molded article according to the present invention, is characterized in that it comprises melting a mixture of a thermoplastic resin (A) and a polyolefin wax (B) which has a number-average molecular weight (Mn) in terms of polyethylene, as measured by gel permeation chromatography, in the range of 200 to 5,000, and a crystallization temperature, as measured by a differential scanning calorimetry (DSC) under the condition of a temperature lowering rate of 2° C./min., in the range of 65 to 120° C., and then subjecting the mixture to blow molding.

The polyolefin wax (B) is a preferably a polyethylene wax, and more preferably a metallocene polyethylene wax.

According to the present invention, a molded product can be obtained by efficient blow molding without deteriorating the physical properties of the molded product, and this process provides excellent moldability.

### DESCRIPTION OF THE PREFERRED EMBODIMENTS

Hereinbelow, the present invention will be described in detail.

[Thermoplastic Resin (A)]

The thermoplastic resin (A) according to the present invention refers to a thermoplastic polymer, or a blend thereof, having a number-average molecular weight (Mn) in terms of polystyrene, as measured by gel permeation chromatography (GPC), of 8,000 or more.

The thermoplastic resin (A) used in the present invention is not particularly limited, but examples thereof include polyolefins such as a low-density polyethylene, a medium-density polyethylene, a high-density polyethylene, a straight-chained low-density polyethylene, polypropylene, a cyclic olefin polymer, an ethylene-propylene copolymer, and a cyclic olefin copolymer;

styrene polymers such as polystyrene, an acrylonitrile-styrene copolymer, and an acrylonitrile-butadiene-styrene copolymer;

polyvinyl chloride, polyvinylidene chloride;

an ethylene-methacrylic acid copolymer, an ethylene-methacrylic acid ester copolymer, an ethylene-vinyl acetate copolymer, an ethylene-vinyl alcohol copolymer;

polycarbonate, polymethacrylate;

polyesters such as polyethylene terephthalate, and polybutylene terephthalate;

polyamides such as Nylon 6, Nylon 11, Nylon 12, Nylon 46, Nylon 66, Nylon MXD6, wholly-aromatic polyamide, and semi-aromatic polyamide;

polyacetal, and a blend of these resins.

Among these thermoplastic resins, polyolefin is preferable; a low-density polyethylene, medium-density polyethylenes, a high-density polyethylene, a straight chained low-density polyethylene, polypropylene, and an ethylene-propylene copolymer are more preferable; and high-density polyethylene, and polypropylene are even more preferable.

If the thermoplastic resin (A) is the above-described resin, the dispersity with the polyolefin wax (B) to be described below is excellent, and thus, a good molded product, for example, surface tackiness-free molded product can be obtained.

The MI (JIS K7210; 190° C., a test load of 2.16 kgf) of the high-density polyethylene is preferably in the range of 0.01 to 1.0 g/10 min., and more preferably in the range of 0.01 to 0.80 g/10 min.

With the MI of the high-density polyethylene in the above range, a molded product which is excellent in texture, rigidity, impact strength, chemical resistance, or the like can be obtained.

Further, the density of the high-density polyethylene is preferably in the range of 942 to 970 kg/m³, more preferably in the range of 944 to 965 kg/m³.

With the density of the high-density polyethylene in the above range, a molded product which is excellent in texture, rigidity, impact strength, chemical resistance, or the like can be obtained.

The MI (JIS K7210; 230° C., a test load of 2.16 kgf) of the polypropylene is preferably in the range of 0.1 to 3.5 g/10 min., and more preferably in the range of 0.4 to 1.5 g/10 min.

With the MI of the polypropylene in the above range, a molded product which is excellent in heat resistance, chemical resistance, or the like can be obtained.

[Polyolefin Wax (B)]

In the present invention, a polyolefin wax is added to the thermoplastic resin (A) for use. In the present invention, the polyolefin wax is one having a crystallization temperature, as measured by a differential scanning calorimetry (DSC) under the condition of a temperature lowering rate of 2° C./min., in the range of 65 to 120° C., and a number-average molecular weight (Mn), as measured by gel permeation chromatography, in the range of 400 to 5,000. When the polyolefin wax is added to the thermoplastic resin (A), and the mixture was melted and then subject to blow molding, the melting viscosity of the resin is lowered, and thus the load of the motor upon extrusion is reduced, as well as the fluidity is improved, thus the molding rate being increased. Further, the surface of the molded product is improved, and thus a molded product having a smooth surface can be obtained. Further, the molding can be effected at a low molding temperature, thus leading to a reduced cooling time, and an improved molding cycle, as well as to suppression of thermal deterioration of the resin, burning and black speck of the resin, and thus excellent strength of the molded product.

The polyolefin wax (B) used in the present invention is not particularly limited, but examples thereof include a polyethylene wax, a polypropylene wax, a wax of an α-olefin homopolymer, a wax of an ethylene/α-olefin copolymer, and a wax of an ethylene/α-olefin/non-conjugated diene copolymer.

Among these polyolefin waxes, a polyethylene wax, and a wax of an ethylene/α-olefin copolymer are preferable; a wax of a copolymer of ethylene and an α-olefin having 3 to 20 carbon atoms is more preferable; a polyethylene wax, a wax of an ethylene/propylene copolymer, a wax of an ethylene/1-butene copolymer, a wax of an ethylene/1-pentene copolymer, a wax of an ethylene/1-hexene copolymer, a wax of an ethylene/4-methyl-1-pentene copolymer, and a wax of an ethylene/1-octene copolymer are even more preferable; a polyethylene wax, a wax of an ethylene/propylene copolymer, a wax of an ethylene/1-butene copolymer, a wax of an ethylene/1-hexene copolymer, and a wax of an ethylene/4-methyl-1-pentene copolymer are particularly preferable.

If the polyolefin wax (B) is the above-described polyolefin wax, the dispersity with the thermoplastic resin (A), particularly the polyolefin resin is excellent, and thus, a good molded product, for example, a molded product with no surface tackiness can be obtained.

The polyolefin wax (B) has a number-average molecular weight (Mn) in terms of polystyrene, as measured by gel permeation chromatography (GPC), in the range of preferably 400 to 5,000, more preferably 700 to 4,500, more particularly preferably 800 to 4,000. The number-average molecular weight (Mn) of 400 to 5,000 in terms of polystyrene is synonymous with the number-average molecular weight (Mn) of 200 to 2,500 in terms of polyethylene.

The number-average molecular weight (Mn) in terms of polyethylene is determined by converting the number-average molecular weight (Mn) in terms of polystyrene according to the calibration method using the coefficient of Mark-Houwink viscosity equation.

The coefficients of the Mark-Houwink viscosity equation are shown as below.
The coefficient of polystyrene: KPS=1.38×10−4, aPS=0.70
The coefficient of polyethyrene: KPE=5.06×10−4, aPE=0.70

With the Mn of the polyolefin wax (B) in the above range, there are provided such the effects as increased improvement on the fluidity, and greatly increased molding rate.

In the present invention, the polyolefin wax (B) may have a number-average molecular weight (Mn) in terms of polyethylene, in the range of more than 2,500 to 5,000.

Therefore, in another aspect of the invention, the polyolefine wax (B) has a number-average molecular weight (Mn) in terms of polyethylene, in the range of preferably 200 to 5,000, more preferably 400 to 5,000.

With the Mn of the polyolefin wax (B) in the above range, there are provided such the effects as increased improvement on the fluidity, and greatly increased molding rate.

The ratio (Mw/Mn) of the weight-average molecular weight (Mw) to the number-average molecular weight (Mn), as measured by gel permeation chromatography (GPC), is in the range of preferably 1.5 to 4.0, more preferably 1.5 to 3.5.

With the Mw/Mn of the polyolefin wax (B) in the above range, a molded product with no surface tackiness can be obtained.

The polyolefin wax (B) has a crystallization temperature, as measured by a differential scanning calorimetry (DSC) under the condition of a temperature lowering rate of 2° C./min., preferably in the range of 65 to 120° C., more preferably in the range of 70 to 120° C., and particularly preferably in the range of 70 to 118° C.

With the crystallization temperature of the polyolefin wax (B) in the above range, a molded product with no surface tackiness can be obtained.

The density of the polyolefin wax (B), as measured by a density gradient tube process in accordance with JIS K7112, is in the range of preferably 850 to 980 kg/m³, more preferably 870 to 980 kg/m³, and even more preferably 890 to 980 kg/m³.

With the density of the polyolefin wax (B) in the above range, the molding shrinkage of the molded product can be easily regulated.

Further, the polyolefin wax (B) satisfies the following relationship represented preferably by the following formula (I), more preferably the following formula (Ia), and even more preferably the following formula (Ib), of the crystallization temperature (Tc(° C.), measured at a temperature lowering rate of 2° C./min.), as measured by a differential scanning calorimetry (DSC), and the density (D (kg/m³)), as measured by a density gradient tube process:
0.501×D−366>Tc (I)
0.501×D−366.5>Tc (Ia)
0.501×D−367>Tc (Ib)

If the crystallization temperature (Tc) and the density (D) of the polyolefin wax (B) satisfies the above formula, for example, the polyolefin wax (B) is an ethylene/α-olefin copolymer, and the compositional distribution of the copolymer is uniform, and as a result, the tackiness of the mixture comprising the thermoplastic resin (A) and the polyolefin wax (B) tends to be reduced.

The penetration hardness of the polyolefin wax (B), as measured in accordance with JIS K2207, is usually 30 dmm or less, preferably 25 dmm or less, more preferably 20 dmm or less, even more preferably 15 dmm or less.

With the penetration hardness of the polyolefin wax (B) in the above range, a molded product having sufficient rigidity can be obtained.

The acetone extraction quantity of the polyolefin wax (B) is in the range of preferably 0 to 20% by weight, more preferably 0 to 15% by weight.

The acetone extraction quantity is a valued measured in the following manner. In a Soxhlet's extractor (made of glass), a filter (ADVANCE, No. 84) is used, and 200 ml of acetone is introduced into a 300 ml round-bottom flask in the lower part. Extraction is carried out in a hot-water bath at 70° C. for 5 hours. 10 g of the first wax is set on the filter.

The polyolefin wax (B) is a solid at room temperature, and is a low-viscosity liquid at 65 to 130° C.

With the acetone extraction quantity of the polyolefin wax (B) in the above range, the content of the tacky components of is decreased, and the fouling of the mold is suppressed, as well as a molded product with no surface tackiness can be obtained.

The process for producing the polyolefin wax (B) is not particularly limited, but the polyolefin wax (B) can be obtained, for example, by the polymerization of monomers such as ethylene, an olefin, and the like using a Ziegler/Natta catalyst or a metallocene catalyst. Among these catalysts, a metallocene catalyst is preferable.

Examples of the metallocene catalyst include a catalyst for olefin polymerization comprising:

(A) a metallocene compound of a transition metal selected from Group 4 of the periodic table, and

(B) at least one kind of the compound selected from (b-1) an organoaluminum oxy-compound,

(b-2) a compound which reacts with the bridged metallocene compound (A) to for ion pairs, and

(b-3) an organoaluminum compound.

Hereinbelow, each of the components will be described in detail.

<Metallocene Compound>

The (A) metallocene compound for forming the metallocene catalyst is a metallocene compound of a transition metal selected from Group 4 of the periodic table, and a specific example thereof is a compound represented by the following formula (1):
M¹Lₓ (1)

In the above formula, M₁ is a transition metal selected from Group 4 of the periodic table, x is a valence of the transition metal M¹, and L is a ligand. Examples of the transition metals indicated by M¹ include zirconium, titanium and hafnium. L is a ligand coordinated to the transition metal M¹, and at least one ligand L is a ligand having cyclopentadienyl skeleton. This ligand having cyclopentadienyl skeleton may have a substituent. Examples of the ligands L having cyclopentadienyl skeleton include a cyclopentadienyl group, alkyl or cycloalkyl substituted cyclopentadienyl groups, such as methylcyclopentadienyl, ethylcyclopentadienyl, n- or i-propylcyclopentadienyl, n-, i-, sec-, or t-butylcyclopentadienyl, dimethylcyclopentadienyl, methylpropylcyclopentadienyl, methylbutylcyclopentadienyl and methylbenzylcyclopentadienyl, an indenyl group, a 4,5,6,7-tetrahydroindenyl group and a fluorenyl group. In these ligands having cyclopentadienyl skeleton, hydrogen may be replaced with a halogen atom, a trialkylsilyl group or the like.

When the metallocene compound has two or more ligands having cyclopentadienyl skeleton as ligands L, two of the ligands having cyclopentadienyl skeleton may be bonded to each other through an alkylene group, such as ethylene or propylene, a substituted alkylene group, such as isopropylidene or diphenylmethylene, a silylene group, or a substituted silylene group, such as dimethylsilylene, diphenylsilylene or methylphenylsilylene.

The ligand L other than the ligand having cyclopentadienyl skeleton (ligand having no cyclopentadienyl skeleton) is, for example, a hydrocarbon group of 1 to 12 carbon atoms, an alkoxy group, an aryloxy group, a sulfonic acid-containing group (—SO₃R¹), wherein R¹ is an alkyl group, an alkyl group substituted with a halogen atom, an aryl group, an aryl group substituted with a halogen atom, or an aryl group substituted with an alkyl group, a halogen atom or a hydrogen atom.

### Example 1 of Metallocene Compound

When the metallocene compound represented by the above formula (1) has a transition metal valence of, for example, 4, this metallocene compound is more specifically represented by the following formula (2):
R²ₖR³ₗR⁴ₘR⁵ₙM¹ (2)

wherein M¹ is a transition metal selected from Group 4 of the periodic table, R² is a group (ligand) having cyclopentadienyl skeleton, and R³, R⁴ and R⁵ are each independently a group (ligand) having or not having cyclopentadienyl skeleton, k is an integer of 1 or greater, and k+l+m+n=4.

Examples of the metallocene compounds having zirconium as M¹ and having at least two ligands having cyclopentadienyl skeleton include
bis(cyclopentadienyl)zirconium monochloride monohydride, bis(cyclopentadienyl)zirconium dichloride, bis(1-methyl-3-butylcyclopentadienyl)zirconium-bis(trifluoromethanesulfonate) and bis(1,3-dimethylcyclopentadienyl)zirconium dichloride.

Also employable are compounds wherein the 1,3-position substituted cyclopentadienyl group in the above compounds is replaced with a 1,2-position substituted cyclopentadienyl group.

As another example of the metallocene compound, a metallocene compound of bridge type wherein at least two of R², R³, R⁴ and R⁵ in the formula (2), e.g., R² and R³, are groups (ligands) having cyclopentadienyl skeleton and these at least two groups are bonded to each other through an alkylene group, a substituted alkylene group, a silylene group, a substituted silylene group or the like is also employable. In this case, R⁴ and R⁵ are each independently the same as the aforesaid ligand L other than the ligand having cyclopentadienyl skeleton.

Examples of the metallocene compounds of bridge type include ethylenebis(indenyl)dimethylzirconium, ethylenebis(indenyl)zirconium dichloride, isopropylidene(cyclopentadienyl-fluorenyl)zirconium dichloride, diphenylsilylenebis(indenyl)zirconium dichloride and methylphenylsilylenebis(indenyl)zirconium dichloride.

### Example 2 of Metallocene Compound

Another example of the metallocene compound is a metallocene compound represented by the following formula (3) that is described in JP-A No. 4-268307.

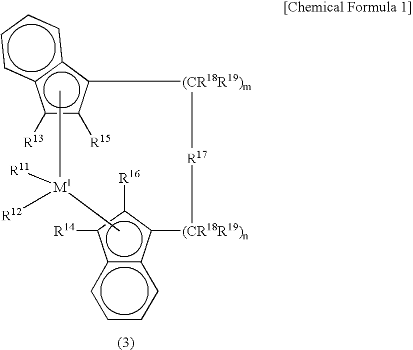

In the above formula, M¹ is a transition metal of Group 4 of the periodic table, specifically titanium, zirconium or hafnium.

R¹¹ and R¹² may be the same as or different from each other and are each a hydrogen atom, an alkyl group of 1 to 10 carbon atoms, an alkoxy group of 1 to 10 carbon atoms, an aryl group of 6 to 10 carbon atoms, an aryloxy group of 6 to 10 carbon atoms, an alkenyl group of 2 to 10 carbon atoms, an arylalkyl group of 7 to 40 carbon atoms, an alkylaryl group of 7 to 40 carbon atoms, an arylalkenyl group of 8 to 40 carbon atoms or a halogen atom. R¹¹ and R¹² are each preferably a chlorine atom.

R¹³ and R¹⁴ may be the same as or different from each other and are each a hydrogen atom, a halogen atom, an alkyl group of 1 to 10 carbon atoms which may be halogenated, an aryl group of 6 to 10 carbon atoms, or a group of —N(R²⁰)₂, —SR₂₀, —OSi(R²⁰), —Si(R²⁰)₃ or —P(R²⁰)₂. R²⁰ is a halogen atom, preferably a chlorine atom, an alkyl group of 1 to 10 carbon atoms (preferably 1 to 3 carbon atoms) or an aryl group of 6 to 10 carbon atoms (preferably 6 to 8 carbon atoms). R¹³ and R¹⁴ are each particularly preferably a hydrogen atom.

R¹⁵ and R¹⁶ are the same as R¹³ and R¹⁴, except that a hydrogen atom is not included, and they may be the same as or different from each other, preferably the same as each other. R¹⁵ and R¹⁶ are each preferably an alkyl group of 1 to 4 carbon atoms which may be halogenated, specifically methyl, ethyl, propyl, isopropyl, butyl, isobutyl, trifluoromethyl or the like, particularly preferably methyl.

In the formula (3), R¹⁷ is selected from the following group.

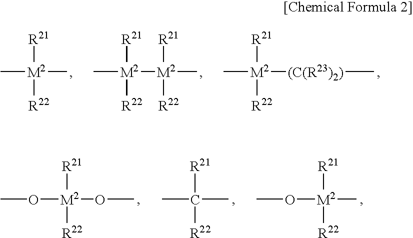

═BR²¹, ═AlR²¹, —Ge—, —Sn—, —O—, —S—, ═SO, ═SO₂, ═NR²¹, ═CO, ═PR²¹, ═P(O)R²¹, etc.

M² is silicon, germanium or tin, preferably silicon or germanium. R²¹, R²² and R²³ may be the same as or different from one another and are each a hydrogen atom, a halogen atom, an alkyl group of 1 to 10 carbon atoms, a fluoroalkyl group of 1 to 10 carbon atoms, an aryl group of 6 to 10 carbon atom, a fluoroaryl group of 6 to 10 carbon atoms, an 10 alkoxy group of 1 to 10 carbon atoms, an alkenyl group of 2 to 10 carbon atoms, an arylalkyl group of 7 to 40 carbon atoms, an arylalkenyl group of 8 to 40 carbon atoms, or an alkylaryl group of 7 to 40 carbon atoms. R²¹ and R²² or R²¹ and R²³ may form a ring together with atoms to which they are bonded. R¹⁷ is preferably ═CR²¹R²², ═SiR²¹R²², ═GeR²¹R²², —O—, —S—, ═SO, ═PR or ═P(O)R²¹. R¹⁸ and R¹⁹ may be the same as or different from each other and are each the same atom or group as that of R²¹. m and n may be the same as or different from each other and are each 0, 1 or 2, preferably 0 or 1, and m+n is 0, 1 or 2, preferably 0 or 1.

Examples of the metallocene compounds represented by the formula (3) include rac-ethylene(2-methyl-1-indenyl)₂-zirconium dichloride and rac-dimethylsilylene (2-methyl-1-indenyl)₂-zirconium dichloride. These metallocene compounds can be prepared by, for example, a process described in JP-A No. 268307/1992.

### Example 3 of Metallocene Compound

As the metallocene compound, a metallocene compound represented by the following formula (4) is also employable.

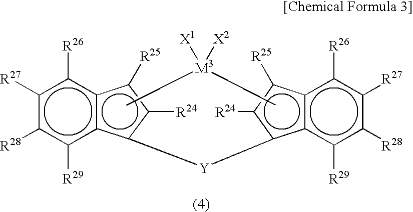

In the formula (4), M³ is a transition metal atom of Group 4 of the periodic table, specifically titanium, zirconium or hafnium. R²⁴ and R²⁵ may be the same as or different from each other and are each a hydrogen atom, a halogen atom, a hydrocarbon group of 1 to 20 carbon atoms, a halogenated hydrocarbon group of 1 to 20 carbon atoms, a silicon-containing group, an oxygen-containing group, a sulfur-containing group, a nitrogen-containing group or a phosphorus-containing group. R²⁴ is preferably a hydrocarbon group, particularly preferably an alkyl group of 1 to 3 carbon atoms, i.e., methyl, ethyl or propyl. R²⁵ is preferably a hydrogen atom or hydrocarbon group, particularly preferably a hydrogen atom or an alkyl group of 1 to 3 carbon atoms, i.e., methyl, ethyl or propyl. R²⁶, R²⁷, R²⁸ and R²⁹ may be the same as or different from one another and are each a hydrogen atom, a halogen atom, a hydrocarbon group of 1 to 20 carbon atoms or a halogenated hydrocarbon group of 1 to 20 carbon atoms. Of these, preferable is a hydrogen atom, a hydrocarbon group or a halogenated hydrocarbon group. At least one combination of “R²⁶ and R²⁷”, “R²⁷ and R²⁸”, and “R²⁸ and R²⁹” may form a monocyclic aromatic ring together with carbon atoms to which they are bonded. When there are two or more hydrocarbon groups or halogenated hydrocarbon groups other than the groups that form the aromatic ring, they may be bonded to each other to form a ring. When R²⁹ is a substituent other than the aromatic group, it is preferably a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁰—, —P(R³⁰)—, —P(O)(R³⁰)—, —BR³⁰— or —AlR³⁰— (R³⁰ is a hydrogen atom, a halogen atom, a hydrocarbon group of 1 to 20 carbon atoms or a halogenated hydrocarbon group of 1 to 20 carbon atoms).

Examples of the ligands in the formula (4) which have a monocyclic aromatic ring formed by mutual bonding of at least one combination of “R²⁶ and R²⁷”, “R²⁷ and R²⁸”, and “R²⁸ and R²⁹” and which are coordinated to M³ include those represented by the following formulas:

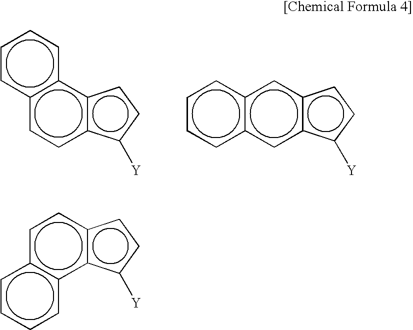

(wherein Y is the same as that described in the above-mentioned formula).

### Example 4 of Metallocene Compound As the metallocene compound, a metallocene compound represented by the following formula (5) is also employable.

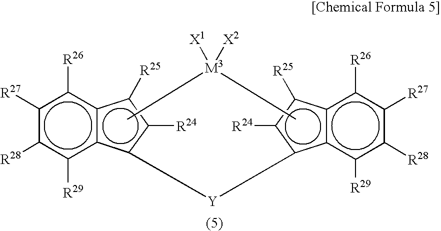

In the formula (5), M³, R²⁴, R²⁵, R²⁶, R²⁷, R²⁸ and R²⁹ are the same as those in the formula (4). Of R²⁶, R²⁷, R²⁸ and R²⁹, two groups including R²⁶ are each preferably an alkyl group, and R²⁶ and R²⁸, or R²⁸ and R²⁹ are each preferably an alkyl group. This alkyl group is preferably a secondary or tertiary alkyl group. Further, this alkyl group may be substituted with a halogen atom or a silicon-containing group. Examples of the halogen atoms and the silicon-containing groups include substituents exemplified with respect to R²⁴ and R²⁵. Of R²⁶, R²⁷, R²⁸ and R²⁹, groups other than the alkyl group are each preferably a hydrogen atom. Two groups selected from R²⁶, R²⁷, R²⁸ and R²⁹ may be bonded to each other to form a monocycle or a polycycle other than the aromatic ring. Examples of the halogen atoms include the same atoms as described with respect to R²⁴ and R²⁵. Examples of X¹, X² and Y include the same atoms and groups as previously described.

Examples of the metallocene compounds represented by the formula (5) include:

rac-dimethylsilylene-bis(4,7-dimethyl-1-indenyl)zirconium dichloride, rac-dimethylsilylene-bis(2,4,7-trimethyl-1-indenyl)zirconium dichloride and rac-dimethylsilylene-bis(2,4,6-trimethyl-1-indenyl)zirconium dichloride.

Also employable are transition metal compounds wherein the zirconium metal is replaced with a titanium metal or a hafnium metal in the above compounds. The transition metal compound is usually used as a racemic modification, but R form or S form is also employable.

### Example 5 of Metallocene Compound

As the metallocene compound, a metallocene compound represented by the following formula (6) is also employable.

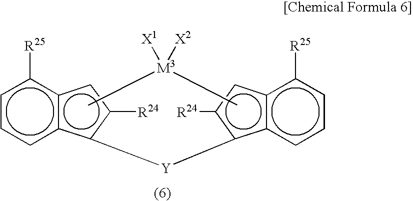

In the formula (6), M3, R²⁴, X¹, X² and Y are the same as those in the formula (4). R²⁴ is preferably a hydrocarbon group, particularly preferably an alkyl group of 1 to 4 carbon atoms, i.e., methyl, ethyl, propyl or butyl. R²⁵ is an aryl group of 6 to 16 carbon atoms. R²⁵ is preferably phenyl or naphthyl. The aryl group may be substituted with a halogen atom, a hydrocarbon group of 1 to 20 carbon atoms or a halogenated hydrocarbon group of 1 to 20 carbon atoms. X¹ and X² are each preferably a halogen atom or a hydrocarbon group of 1 to 20 carbon atoms.

Examples of the metallocene compounds represented by the formula (6) include:

rac-dimethylsilylene-bis(4-phenyl-1-indenyl)zirconium dichloride, rac-dimethylsilylene-bis(2-methyl-4-phenyl-1-indenyl)zirconium dichloride, rac-dimethylsilylene-bis(2-methyl-4-(α-naphthyl)-1-indenyl)zirconium dichloride, rac-dimethylsilylene-bis(2-methyl-4-(β-naphthyl)-1-indenyl)zirconium dichloride and rac-dimethylsilylene-bis(2-methyl-4-(1-anthryl)-1-indenyl)zirconium dichloride. Also employable are transition metal compounds wherein the zirconium metal is replaced with a titanium metal or a hafnium metal in the above compounds.

### Example 6 of Metallocene Compound

As the metallocene compound, a metallocene compound represented by the following formula (7) is also employable.
LaM⁴X³₂ (7)

In the above formula, M⁴ is a metal of Group 4 or lanthanide series of the periodic table. La is a derivative of a delocalized π bond group and is a group imparting a constraint geometric shape to the metal M⁴ active site. Each X³ may be the same or different and is a hydrogen atom, a halogen atom, a hydrocarbon group of 20 or less carbon atoms, a silyl group having 20 or less silicon atoms or a germyl group having 20 or less germanium atoms.

Of such compounds, a compound represented by the following formula (8) is preferable.

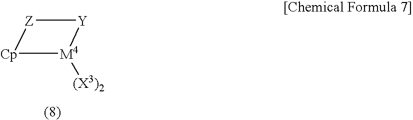

In the formula (8), M⁴ is titanium, zirconium or hafnium. X³ is the same as that described in the formula (7). Cp is π-bonded to M⁴ and is a substituted cyclopentadienyl group having a substituent Z. Z is oxygen, sulfur, boron or an element of Group 4 of the periodic table (e.g., silicon, germanium or tin). Y is a ligand having nitrogen, phosphorus, oxygen or sulfur, and Z and Y may together form a condensed ring. Examples of the metallocene compounds represented by the formula (8) include:

(dimethyl(t-butylamide)(tetramethyl-η⁵-cyclopentadienyl)silane)titanium dichloride and ((t-butylamide)(tetramethyl-η⁵-cyclopentadienyl)-1,2-ethanediyl)titanium dichloride. Also employable are metallocene compounds wherein titanium is replaced with zirconium or hafnium in the above compounds.

### Example 7 of Metallocene Compound

As the metallocene compound, a metallocene compound represented by the following formula (9) is also employable.

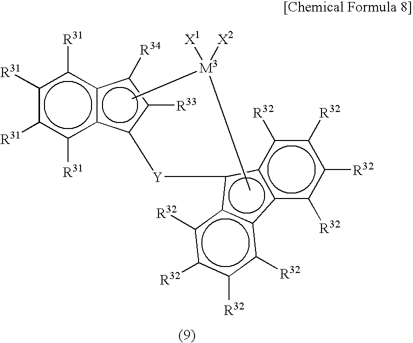

In the formula (9), M³ is a transition metal atom of Group 4 of the periodic table, specifically titanium, zirconium or hafnium, preferably zirconium. Each R³¹ may be the same or different, and at least one of them is an aryl group of 11 to 20 carbon atoms, an arylalkyl group of 12 to 40 carbon atoms, an arylalkenyl group of 13 to 40 carbon atoms, an alkylaryl group of 12 to 40 carbon atoms or a silicon-containing group, or at least two neighboring groups of the groups indicated by R³¹ form single or plural aromatic rings or aliphatic rings together with carbon atoms to which they are bonded. In this case, the ring formed by R³¹ has 4 to 20 carbon atoms in all including carbon atoms to which R³¹ is bonded. R³¹ other than R³¹ that is an aryl group, an arylalkyl group, an arylalkenyl group or an alkylaryl group or that forms an aromatic ring or an aliphatic ring is a hydrogen atom, a halogen atom, an alkyl group of 1 to 10 carbon atoms or a silicon-containing group. Each R³² may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. At least two neighboring groups of the groups indicated by R³² may form single or plural aromatic rings or aliphatic rings together with carbon atoms to which they are bonded. In this case, the ring formed by R³² has 4 to 20 carbon atoms in all including carbon atoms to which R³² is bonded. R³² other than R³² that forms an aromatic ring or an aliphatic ring is a hydrogen atom, a halogen atom, an alkyl group of 1 to 10 carbon atoms or a silicon-containing group. In the groups constituted of single or plural aromatic rings or aliphatic rings formed by two groups indicated by R³², an embodiment wherein the fluorenyl group part has such a structure as represented by the following formula is included.

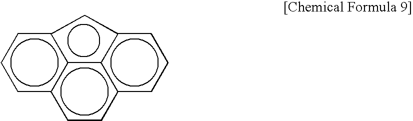

R³² is preferably a hydrogen atom or an alkyl group, particularly preferably a hydrogen atom or a hydrocarbon group of 1 to 3 carbon atoms, i.e., methyl, ethyl or propyl. A preferred example of the fluorenyl group having R³² as such a substituent is a 2,7-dialkyl-fluorenyl group, and in this case, an alkyl group of the 2,7-dialkyl is, for example, an alkyl group of 1 to 5 carbon atoms. R³¹ and R³² may be the same as or different from each other. R³³ and R³⁴ may be the same as or different from each other and are each a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, and arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group, similarly to the above. At least one of R³³ and R³⁴ is preferably an alkyl group of 1 to 3 carbon atoms. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. Preferred examples of the conjugated diene residues formed from X¹ and X² include residues of 1,3-butadiene, 2,4-hexadiene, 1-phenyl-1,3-pentadiene and 1,4-diphenylbutadiene, and these residues may be further substituted with a hydrocarbon group of 1 to 10 carbon atoms. X¹ and X² are each preferably a halogen atom, a hydrocarbon group of 1 to 20 carbon atoms or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁵—, —P(R³⁵)—, —P(O)(R³⁵)—, —BR³⁵— or —AlR³⁵— (R³⁵ is a hydrogen atom, a halogen atom, a hydrocarbon group of 1 to 20 carbon atoms or a halogenated hydrocarbon group of 1 to 20 carbon atoms). Of these divalent groups, preferable are those wherein the shortest linkage part of —Y— is constituted of one or two atoms. R³⁵ is a halogen atom, a hydrocarbon group of 1 to 20 carbon atoms or a halogenated hydrocarbon group of 1 to 20 carbon atoms. Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

### Example 8 of Metallocene Compound

As the metallocene compound, a metallocene compound represented by the following formula (10) is also employable.

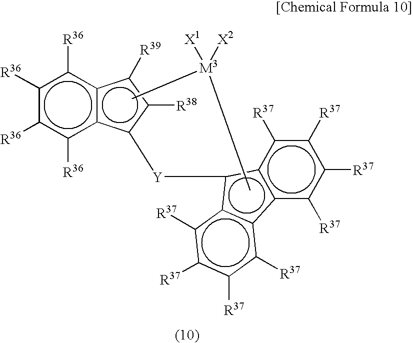

In the formula (10), M³ is a transition metal atom of Group 4 of the periodic table, specifically titanium, zirconium or hafnium, preferably zirconium. Each R³⁶ may be the same or different and is a hydrogen atom, a halogen atom, an alkyl group of 1 to 10 carbon atoms, an aryl group of 6 to 10 carbon atoms, an alkenyl group of 2 to 10 carbon atoms, a silicon-containing group, an oxygen-containing group, a sulfur-containing group, a nitrogen-containing group or a phosphorus-containing group. The alkyl group and the alkenyl group may be substituted with a halogen atom. R³⁶ is preferably an alkyl group, an aryl group or a hydrogen atom, particularly preferably a hydrocarbon group of 1 to 3 carbon atoms, i.e., methyl, ethyl, n-propyl or i-propyl, an aryl group, such as phenyl, α-naphthyl or β-naphthyl, or a hydrogen atom. Each R³⁷ may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. The alkyl group, the aryl group, the alkenyl group, the arylalkyl group, the arylalkenyl group and the alkylaryl group may be substituted with halogen. R³⁷ is preferably a hydrogen atom or an alkyl group, particularly preferably a hydrogen atom or a hydrocarbon group of 1 to 4 carbon atoms, i.e., methyl, ethyl, n-propyl, i-propyl, n-butyl or tert-butyl. R³⁶ and R³⁷ may be the same as or different from each other. One of R³⁸ and R³⁹ is an alkyl group of 1 to 5 carbon atoms, and the other is a hydrogen atom, a halogen atom, an alkyl group of 1 to 10 carbon atoms, an alkenyl group of 2 to 10 carbon atoms, a silicon-containing group, an oxygen-containing group, a sulfur-containing group, a nitrogen-containing group or a phosphorus-containing group. It is preferable that one of R³⁸ and R³⁹ is an alkyl group of 1 to 3 carbon atoms, such as methyl, ethyl or propyl, and the other is a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. X¹ and X² are each preferably a halogen atom or a hydrocarbon group of 1 to 20 carbon atoms. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR⁴⁰—, —P(R⁴⁰)—, —P(O)(R⁴⁰)—, —BR⁴⁰— or —AlR⁴⁰— (R⁴⁰ is a hydrogen atom, a halogen atom, a hydrocarbon group of 1 to 20 carbon atoms or a halogenated hydrocarbon group of 1 to 20 carbon atoms). Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

### Example 9 of Metallocene Compound

As the metallocene compound, a metallocene compound represented by the following formula (11) is also employable.

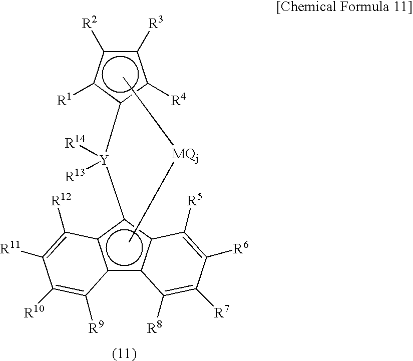

In the formula (11), Y is selected from carbon, silicon, germanium and tin atoms, M is Ti, Zr or Hf, R¹, R², R³, R⁴, R⁵, R⁶, R⁷, R⁸, R⁹, R¹⁰, R¹¹ and R¹² may be the same as or different from each other, and selected from hydrogen, a hydrocarbon group, and a silicon containing group, the adjacent substituents of R⁵ to R¹² may be bonded to each other to form a ring, R¹³ and R¹⁴ may be the same as or different from each other, and selected from a hydrocarbon group, and a silicon containing group, and R¹³ and R¹⁴ may be bonded to each other to form a ring. Q may be selected in the same or different combination from halogen, a hydrocarbon group, an anionic ligand, and a neutral ligand which can be coordinated to a lone pair of electrons, and j is an integer of 1 to 4. Hereinbelow, the cyclopentadienyl group, the fluorenyl group, and the bridged part which are the characteristics in the chemical structure of the metallocene compound used in the present invention, and other characteristics are sequentially explained, and then preferred metallocene compounds having both these characteristics are also explained.

Cyclopentadienyl Group

The cyclopentadienyl group may be substituted or unsubstituted. The phrase “substituted or unsubstituted cyclopentadienyl group” means a cyclopentadienyl group in which R¹, R², R³, and R⁴ of the cyclopentadienyl skeleton in the formula (11) are all hydrogen atoms, or at least one of R¹, R², R³, and R⁴ is a hydrocarbon group (f1), preferably a hydrocarbon group (f1′) having a total of 1 to 20 carbon atoms, or a silicon-containing group (f2), preferably a silicon-containing group (f2′) having a total of 1 to 20 carbon atoms. If at least two of R¹, R², R³, and R⁴ are substituted, the substituents may be the same as or different from each other. Further, the phrase “hydrocarbon group having a total of 1 to 20 carbon atoms” means an alkyl group, an alkenyl group, an alkynyl group, or an aryl group, which is composed of only carbon and hydrogen. It includes one in which both of any two adjacent hydrogen atoms are substituted to form an alicyclic or aromatic ring. Examples of the hydrocarbon group (f1′) having a total of 1 to 20 carbon atoms includes, in addition to an alkyl group, an alkenyl group, an alkynyl group, or an aryl group, which is composed of only carbon and hydrogen, a heteroatom-containing hydrocarbon group which is a hydrocarbon group in which a part of the hydrogen atoms directly bonded to carbon atoms are substituted with a halogen atom, an oxygen-containing group, a nitrogen-containing group, or a silicon-containing group, and an alicyclic group in which any two hydrogen atoms which are adjacent to each other are substituted. Examples of the hydrocarbon group (f1′) include:

a linear hydrocarbon group such as a methyl group, an ethyl group, an n-propyl group, an allyl group, an n-butyl group, an n-pentyl group, an n-hexyl group, an n-heptyl group, an n-octyl group, an n-nonyl group, and an n-decanyl group;

a branched hydrocarbon group such as an isopropyl group, a t-butyl group, an amyl group, a 3-methylpentyl group, a 1,1-diethylpropyl group, a 1,1-dimethylbutyl group, a 1-methyl-1-propyl butyl group, a 1,1-propyl butyl group, a 1,1-dimethyl-2-methylpropyl group, and a 1-methyl-1-isopropyl-2-methylpropyl group;

a cycloalkane group such as a cyclopentyl group, a cyclohexyl group, a cycloheptyl group, a cyclooctyl group, a norbornyl group, and an adamanthyl group;

a cyclic, unsaturated hydrocarbon group and a nuclear alkyl-substituted product thereof such as a phenyl group, a naphthyl group, a biphenyl group, a phenanthryl group, and an anthracenyl group;

a saturated hydrocarbons group substituted with an aryl group such as benzyl group and a cumyl group;

a heteroatom-containing hydrocarbon group such as a methoxy group, an ethoxy group, a phenoxy group, an N-methylamino group, a trifluoromethyl group, a tribromomethyl group, a pentafluoroethyl group, and a pentafluorophenyl group.

The phrase “silicon-containing group (f₂)” means a group in which ring carbons of the cyclopentadienyl group are directly covalently bonded, and specific examples thereof include an alkyl silyl group and an aryl silyl group. Examples of the silicon-containing group (f2′) having a total of 1 to 20 carbon atoms include a trimethylsilyl group, and a triphenylsilyl group.

Fluorenyl Group

The fluorenyl group may be substituted or unsubstituted. The phrase “substituted or unsubstituted fluorenyl group” means a fluorenyl group in which R⁵, R⁶, R⁷, R⁸, R⁹, R¹⁰, R¹¹, and R¹² of the fluorenyl skeleton in the formula (11) are all hydrogen atoms, or at least one of R⁵, R⁶, R⁷, R⁸, R⁹, R¹⁰, R¹¹, and R¹² is a hydrocarbon group (f1), preferably a hydrocarbon group (f1′) having a total of 1 to 20 carbon atoms, or a silicon-containing group (f2), preferably a silicon-containing group (f2′) having a total of 1 to 20 carbon atoms. If at least two of R⁵, R⁶, R⁷, R⁸, R⁹, R¹⁰, R¹¹, and R¹² are substituted, the substituents may be the same as or different from each other. R⁵, R⁶, R⁷, R⁸, R⁹, R¹⁰, R¹¹, and R¹² may be bonded to each other to form a ring. From a viewpoint of easy preparation of a catalyst, R⁶ and R¹¹, and R⁷ and R¹⁰ are preferably the same to each other.

A preferable example of the hydrocarbon group (f1) is a hydrocarbon group (f1′) having a total of 1 to 20 carbon atoms, and a preferable example of the silicon-containing group (f2) is a silicon-containing group (f2′) having a total of 1 to 20 carbon atoms.

Covalent Bond Bridging

The main chain of the bond which binds the cyclopentadienyl group with the fluorenyl group is a divalent covalent bond bridging containing a carbon atom, a silicon atom, a germanium atom and a tin atom. An important point when carrying out a high temperature solution polymerization is that a bridging atom Y of the covalent bond bridging part has R¹³ and R¹⁴ which may be the same as or different from each other. A preferable example of the hydrocarbon group (f1) is a hydrocarbon group (f1′) having a total of 1 to 20 carbon atoms, and a preferable example of the silicon-containing group (f2) is a silicon-containing group (f2′) having a total of 1 to 20 carbon atoms.

Other Characteristics of Bridged Metallocene Compound

As for other characteristics of the bridged metallocene compound, in the above-described formula (11), Q is selected in the same or different combination from halogen, a hydrocarbon group having 1 to 10 carbon atoms, a neutral, conjugated or non-conjugated diene having 10 carbon atoms or less, an anionic ligand, and a neutral ligand which can be coordinated to a lone pair of electrons. Specific examples of halogen include fluorine, chlorine, bromine, and iodine, and specific examples of the hydrocarbon group include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η4-1,3-pentadiene, s-cis- or s-trans-η⁴-1,4-ditolyl-1,3-butadiene, and s-cis- or s-trans-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated to a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. j is an integer of 1 to 4, and when j is no less than 2, Q's may be the same as or different from each other.

### Example 10 of Metallocene Compound

As the metallocene compound, a metallocene compound represented by the following formula (12) is also employable.

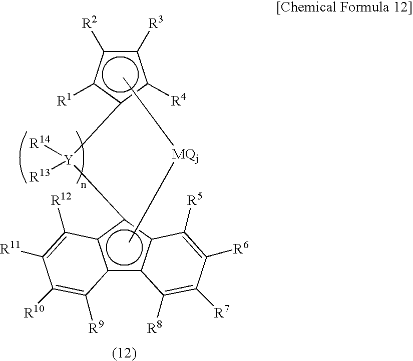

In the above formula, R¹, R², R³, R⁴, R⁵, R⁶, R⁷, R⁸, R⁹, R¹⁰, R¹¹, R¹², R¹³, may be the same as or different from each other, and selected from hydrogen, a hydrocarbon group, and a silicon containing group, the adjacent substituents of R¹ to R¹⁴ may be bonded to each other to form a ring, M is Ti, Zr or Hf, Y is an atom of Group 14 of the periodic table, Q is selected in the same or different combination from halogen, a hydrocarbon group, a neutral, conjugated or non-conjugated diene having 10 carbon atoms or less, an anionic ligand, and a neutral ligand which can be coordinated to a lone pair of electrons, n is an integer of 2 to 4, and j is an integer of 1 to 4.

In the formula (12), the hydrocarbon group is preferably an alkyl group having 1 to 20 carbon atoms, an aryl group having 7 to 20 carbon atoms, an aryl group having 6 to 20 carbon atoms, or an alkylaryl group having 7 to 20 carbon atoms, and may contain at least one ring structure.

Specific examples thereof include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethyl butyl, neopentyl, cyclohexylmethyl, cyclohexyl, 1-methyl-1-cyclohexyl, 1-adamanthyl, 2-adamanthyl, 2-methyl-2-adamanthyl, menthyl, norbornyl, benzyl, 2-phenylethyl, 1-tetrahydro naphthyl, 1-methyl-1-tetrahydro naphthyl, phenyl, naphthyl, and tolyl.

In the formula (12), the silicon-containing group is preferably an alkyl or arylsilyl group having 1 to 4 silicon atoms and 3 to 20 carbon atoms, and specific examples thereof include trimethylsilyl, tert-butyldimethylsilyl, and triphenylsilyl.

In the present invention, R¹ to R¹⁴ in the formula (12) are selected from hydrogen, a hydrocarbon group, and a silicon-containing hydrocarbon group, and may be the same as or different from each other. Preferable examples of the hydrocarbon group and the silicon-containing group are as described above.

The adjacent substituents of R¹ to R¹⁴ in the cyclopentadienyl ring in the formula (12) may be bonded to each other to form a ring.

M of the formula (12) is an element of Group 4 of the periodic table, that is, zirconium, titanium or hafnium, preferably zirconium.

Y is an atom of Group 14 of the periodic table, preferably a carbon atom or a silicon atom. n is an integer of 2 to 4, preferably 2 to 3, and particularly preferably 2.

Q is selected in the same or different combination from halogen, a hydrocarbon group, a neutral, conjugated or non-conjugated diene having 10 carbon atoms or less, an anionic ligand, and a neutral ligand which can be coordinated to a lone pair of electrons. If Q is a hydrocarbon group, it is more preferably a hydrocarbon group having 1 to 10 carbon atoms.

Specific examples of halogen include fluorine, chlorine, bromine, and iodine, and specific examples of the hydrocarbon group include methyl, ethyl, n-propyl, isopropyl, 2-methylpropyl, 1,1-dimethylpropyl, 2,2-dimethylpropyl, 1,1-diethylpropyl, 1-ethyl-l-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η⁴-1,3-pentadiene, s-cis- or s-trans-η⁴-1,4-ditolyl-1,3-butadiene, and s-cis- or s-trans-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated to a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. When j is no less than 2, Q's may be the same as or different from each other.

In the formula (12), 2 to 4 Y's are present, and Y's may be the same as or different from each other. A plurality of R¹³'s and a plurality of R¹⁴'s may be the same as or different from each other. For example, a plurality of R¹³'s which are bonded to the same Y may be different from each other, and a plurality of R¹³'s which are bonded to the different Y's may be the same to each other. Otherwise, R¹³'s and R¹⁴'s may be taken to form a ring.

Preferable examples of the compound represented by the formula (12) include a transition metal compound represented by the following formula (13).

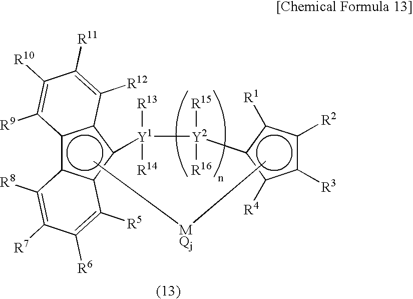

In the formula (13), R¹, R², R³, R⁴, R⁵, R⁶, R⁷, R⁸, R⁹, R¹⁰, R¹¹, and R¹² may be the same as or different from each other, and selected from hydrogen, a hydrocarbon group, and a silicon containing group, R¹³, R¹⁴, R¹⁵, and R¹⁶ are hydrogen, or a hydrocarbon group, and n is an integer of 1 to 3. With n=1, R¹ to R¹⁶ are not hydrogen at the same time, and each may be the same as or different from each other. The adjacent substituents of R⁵ to R¹² may be bonded to each other to form a ring, R¹³ and R¹⁵ may be bonded to each other to form a ring, and R¹³ and R¹⁵, and R¹⁴ and R¹⁶ may be bonded to each other to form a ring at the same time, Y¹ and Y² are atoms of Group 14 of the periodic table, M is Ti, Zr or Hf. Q is selected in the same or different combination from halogen, a hydrocarbon group, an anionic ligand, and a neutral ligand which can be coordinated to a lone pair of electrons, and j is an integer of 1 to 4.

The compounds such as those as described in (Example 9 of Metallocene Compound) and (Example 10 of Metallocene Compound) are mentioned in JP-A No. 2004-175707, WO2001/027124, WO2004/029062, and WO2004/083265.

The metallocene compounds described above are used singly or in combination of two or more kinds. The metallocene compounds may be used after diluted with hydrocarbon, halogenated hydrocarbon or the like.

Hereinbelow, the component (B) will be described specifically.

<(b-1) Organoaluminum Oxy-Compound>

According to the present invention, as the organoaluminum oxy-compound (b-1), publicly known aluminoxane can be used as it is. Specifically, such publicly known aluminoxane is represented by the following formula (14)

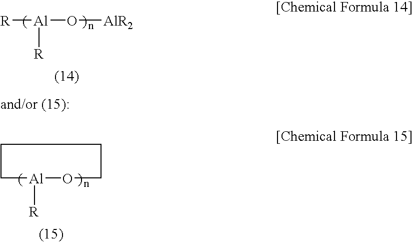

wherein R represents a hydrocarbon group having 1 to 10 carbon atoms, and n represents an integer of 2 or more. Among these compound, the methyl aluminoxane in which R is a methyl group and n is 3 or more, preferably 10 or more are preferably used. These aluminoxanes may be incorporated with some organoaluminum compounds. In addition, when a high temperature solution polymerization is carried out, the benzene-insoluble organoaluminum oxy-compounds as described in JP-A No. 2-78687 can be employed. Further, the organoaluminum oxy-compounds as described in JP-A No. 2-167305, and the aluminoxanes having at least two kinds of alkyl groups as described in JP-A Nos. 2-167305, 2-24701, and 3-103407 are preferably used. In addition, the phrase “benzene insoluble” regarding the organoaluminum oxy-compounds, the proportion of the Al components dissolved in benzene at 60° C. in terms of an Al atom is usually 10% or less, preferably 5% or less, and particularly preferably 2% or less, and that is, the compound has insolubility or poor solubility in benzene.

Examples of the organoaluminum oxy-compound (b-1) used in the present invention include a modified methyl aluminoxane having the structure of the following structure (16).

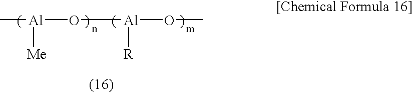

(wherein R represents a hydrocarbon group having 1 to 10 carbon atoms, and m and n represent integers of 2 or more). This modified methyl aluminoxane is prepared from trimethyl aluminum and alkyl aluminum other than trimethyl aluminum. This modified methyl aluminoxane is generally referred to as MMAO. Such the MMAO can prepared by the method as described in U.S. Pat. Nos. 4,960,878 and 5,041,584.

Further, the modified methyl aluminoxane in which R is an iso-butyl group, prepared from trimethyl aluminum and tri-isobutyl aluminum from Tosoh Finechem Corp., is commercially produced in a trade name of MMAO or TMAO. The MMAO is aluminoxane with improved solubility in various solvents, and storage stability, and specifically, it is dissolved in an aliphatic or alicyclic hydrocarbon, although the aluminoxane described for the formula (14) or (15) has insolubility or poor solubility in benzene.

Further, examples of the organoaluminum oxy-compound (b-1) used in the present invention include a boron-containing organoaluminum oxy-compound represented by the following formula (17).

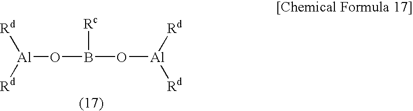

(wherein R^{c} represents a hydrocarbon group having 1 to 10 carbon atoms, R^{d}'s may be the same as or different from each other, and represent a hydrogen atom, a halogen atom or a hydrocarbon group having 1 to 10 carbon atoms).

<(b-2) Compounds Which React with the Metallocene Compound (A) to Form an Ion Pair>

Examples of the compound (B-2) which reacts with the metallocene compound (A) to form an ion pair (referred to as an “ionic compound” hereinafter) may include Lewis acids, ionic compounds, borane compounds and carborane compounds, as described in each publication of JP-A Nos. 1-501950, 1-502036, 3-179005, 3-179006, 3-207703 and 3-207704, and U.S. Pat. No. 5,321,106. They also include a heteropoly compound and an iso-poly compound.

According to the present invention, the ionic compound which is preferably employed is a compound represented by the following formula (18).

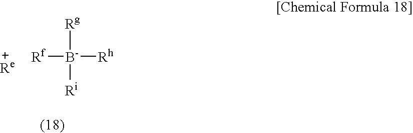

wherein examples of R^{e+} include H⁺, a carbenium cation, an oxonium cation, an ammonium cation, a phosphonium cation, a cycloheptyltrienyl cation, and a ferrocenium cation having transition metal. R^{f} to Rⁱ may be the same as or different from each other, and each represent an organic group, preferably an aryl group.

Specific examples of the carbenium cation include 3-substituted carbenium cations such as a triphenyl carbenium cation, a tris(methylphenyl) carbenium cation, and a tris(dimethylphenyl) carbenium cation.

Specific examples of the ammonium cation include a trialkyl ammonium cation such as a trimethyl ammonium cation, a triethyl ammonium cation, a tri(n-propyl)ammonium cation, a tri-isopropyl ammonium cation, a tri(n-butyl)ammonium cation, and a tri-isobutyl ammonium cation, a N,N-dialkyl anilinium cation such as an N,N-dimethyl anilinium cation, an N,N-diethyl anilinium cation, and an N,N-2,4,6-pentamethyl anilinium cation, and a dialkyl ammonium cation such as a diisopropyl ammonium cation and a dicyclohexyl ammonium cation.

Specific examples of the phosphonium cation include a triaryl phosphonium cation such as a triphenylphosphonium cation, tris(methylphenyl)phosphonium cation, and tris(dimethylphenyl)phosphonium cation.

Among them, R^{e+} is preferably a carbenium cation, an ammonium cation, or the like, and particularly preferably a triphenylcarbenium cation, a N,N-dimethyl anilinium cation, or an N,N-diethyl anilinium cation.

Specific examples of the carbenium salts include triphenyl carbenium tetraphenylborate, triphenyl carbenium tetrakis(pentafluorophenyl)borate, triphenyl carbenium tetrakis(3,5-ditrifluoromethylphenyl)borate, tris(4-methylphenyl) carbenium tetrakis(pentafluorophenyl)borate, and tris(3,5-dimethylphenyl) carbenium tetrakis(pentafluorophenyl)borate.

Examples of the ammonium salt include a trialkyl-substituted ammonium salt, an N,N-dialkyl anilinium salt, and a dialkyl ammonium salt.

Examples of the trialkyl-substituted ammonium salt include triethyl ammonium tetraphenyl borate, tripropyl ammonium tetraphenyl borate, tri(n-butyl)ammonium tetraphenyl borate, trimethyl ammonium tetrakis(p-tolyl)borate, trimethyl ammonium tetrakis(o-tolyl)borate, tri(n-butyl)ammonium tetrakis(pentafluorophenyl)borate, triethyl ammonium tetrakis(pentafluorophenyl)borate, tripropyl ammonium tetrakis(pentafluorophenyl)borate, tripropyl ammonium tetrakis(2,4-dimethylphenyl)borate, tri(n-butyl)ammonium tetrakis(3,5-dimethylphenyl)borate, tri(n-butyl)ammonium tetrakis(4-trifluoromethylphenyl)borate, tri(n-butyl)ammonium tetrakis(3,5-ditrifluoromethylphenyl)borate, tri(n-butyl)ammonium tetrakis(o-tolyl)borate, dioctadecyl methyl ammonium tetraphenyl borate, dioctadecyl methyl ammonium tetrakis(p-tolyl)borate, dioctadecyl methyl ammonium tetrakis(o-tolyl)borate, dioctadecyl methyl ammonium tetrakis(pentafluorophenyl)borate, dioctadecyl methyl ammonium tetrakis(2,4-dimethylphenyl)borate, dioctadecyl methyl ammonium tetrakis(3,5-dimethylphenyl)borate, dioctadecyl methyl ammonium tetrakis(4-trifluoromethylphenyl)borate, dioctadecyl methyl ammonium tetrakis(3,5-ditrifluoromethylphenyl)borate, and dioctadecyl methyl ammonium.

Examples of the N,N-dialkyl anilinium salt, include N,N-dimethyl anilinium tetraphenyl borate, N,N-dimethyl anilinium tetrakis(pentafluorophenyl)borate, N,N-dimethyl anilinium tetrakis(3,5-ditrifluoromethylphenyl)borate, N,N-diethyl anilinium tetraphenyl borate, N,N-diethyl anilinium tetrakis(pentafluorophenyl)borate, N,N-diethyl anilinium tetrakis(3,5-ditrifluoromethylphenyl)borate, N,N-2,4,6-pentamethyl anilinium tetraphenyl borate, and N,N-2,4,6-pentamethyl anilinium tetrakis(pentafluorophenyl)borate.

Examples of the dialkyl ammonium salt include di(1-propyl)ammonium tetrakis(pentafluorophenyl)borate, and dicyclohexyl ammonium tetraphenyl borate.

The ionic compounds as disclosed in JP-A No. 2004-51676 by the present Applicant can be used without any restriction.

The ionic compounds (b-2) can be used in a mixture of two or more kinds.

<(b-3) Organoaluminum Compound>

Examples of the organoaluminum compound (b-3) which constitutes the catalyst for olefin polymerization include an organoaluminum compound represented by the following formula (X), and an alkylated complex with a metal element from Group 1 of the periodic table and aluminum, which is represented by the following formula (19):
R^{a}ₘAl(OR^{b})ₙHₚX_{q} (19)

(wherein Ra and Rb are may be the same as or different from each other and each represent a hydrocarbon group having usually 1 to 15 carbon atoms, preferably 1 to 4 carbon atoms, X is a halogen atom, and m, n, p, and q are numbers satisfying the conditions: 0<m ≦3, 0≦n<3, 0≦p<3, and 0≦q<3, while m+n+p+q=3). Specific examples of the compound represented by the formula (19) include tri-n-alkyl aluminum such as trimethyl aluminum, triethyl aluminum, tri-n-butyl aluminum, trihexyl aluminum, and trioctyl aluminum; tri-branch chained alkyl aluminum such as tri-isopropyl aluminum, tri-isobutyl aluminum, tri-sec-butyl aluminum, tri-tert-butyl aluminum, tri-2-methylbutyl aluminum, tri-3-methyl hexyl aluminum, and tri-2-ethylhexyl aluminum; tri-cycloalkyl aluminum such as tri-cyclohexyl aluminum, and tri-cyclooctyl aluminum; triaryl aluminum such as triphenyl aluminum, and tritolyl aluminum; dialkyl aluminum hydride such as diisopropyl aluminum hydride, and diisobutyl aluminum hydride; alkenyl aluminum, such as isoprenyl aluminum, represented by the formula: (i-C₄H₉)ₓAl_{y}(C₅H₁₀)_{z} (wherein x, y and z are positive integers, and z is the numbers satisfying the conditions: z≦2x); alkyl aluminum alkoxide such as isobutyl aluminum methoxide, and isobutyl aluminum ethoxide; dialkyl aluminum alkoxide such as dimethyl aluminum methoxide, diethyl aluminum ethoxide, and dibutyl aluminum butoxide; alkyl aluminum sesquialkoxide such as ethyl aluminum sesquiethoxide, and butyl aluminum sesquibutoxide; partially alkoxylated alkyl aluminum, for example, having a mean compositions represented by the general formula R^{a}_{2.5}Al(OR^{b})_{0.5}; alkyl aluminum aryloxy such as diethyl aluminum phenoxide, diethyl aluminum (2,6-di-t-butyl-4-methylphenoxide); dialkyl aluminum halide such as dimethyl aluminum chloride, diethyl aluminum chloride, dibutyl aluminum chloride, diethyl aluminum bromide, and diisobutyl aluminum chloride; alkyl aluminum sesquihalide such as ethyl aluminum sesquichloride, butyl aluminum sesquichloride, and ethyl aluminum sesquibromide; partially halogenated alkyl aluminum of alkyl aluminum dihalide such as ethyl aluminum dichloride; dialkyl aluminum hydride such as diethyl aluminum hydride, and dibutyl aluminum hydride; other partially hydrogenated alkyl aluminum, for example, alkyl aluminum dihydrides such as ethyl aluminum dihydride and propyl aluminum dihydride; and partially alkoxylated and halogenated alkyl aluminums such as ethyl aluminum ethoxychloride, butyl aluminum butoxychloride and ethyl aluminum ethoxybromide.

Examples of an alkylated complex with a metal element from Group 1 of the periodic table and aluminum, represented by the following formula (20):
M²AlR^{a}₄ (20)

(wherein M² is Li, Na or K, and R^{a} is a hydrocarbon group having usually 1 to 15 carbon atoms, preferably 1 to 4 carbon atoms) include LiAl(C₂H₅)₄ and LiAl(C₇H₁₅)₄.

The compounds similar to the compounds represented by the formula (20), for example, the organoaluminum compounds in which two or more aluminum compounds are bonded via a nitrogen atom, can be used. Specific examples thereof include (C₂H₅)₂AlN(C₂H₅)Al(C₂H₅)₂.

From a viewpoint of easy availability, as an organoaluminum compound (b-3), trimethyl aluminum or tri-isobutyl aluminum is preferably used.

<Polymerization>

The polyethylene wax used in the invention is obtained by homopolymerizing ethylene usually in a liquid phase or homopolymerizing or copolymerizing ethylene and an α-olefin usually in a liquid phase, in the presence of the above-mentioned metallocene catalyst. In the polymerization, the method for using each of the components, and the sequence of addition are optionally selected, but the following methods may be mentioned.

[q1] A method for adding a component (A) alone to a polymerization reactor.

[q2] A method for adding a component (A) and a component (B) to a polymerization reactor in any order.

For the [q2] method, at least two of each catalyst components may be in contact with each other beforehand. At this time, a hydrocarbon solvent is generally used, but an α-olefin may be used as a solvent. In addition, the monomers used herein are as previously described.

As the polymerization process, suspension polymerization wherein polymerization is carried out in such a state that the polyethylene wax is present as particles in a solvent such as hexane, or gas phase polymerization wherein a solvent is not used, or solution polymerization wherein polymerization is carried out at a polymerization temperature of not lower than 140° C. in such a state that the polyethylene wax is molten in the presence of a solvent or is molten alone is employable. Among these, solution polymerization is preferable in both aspects of economy and quality.

The polymerization reaction may be carried out as any of a batch process and a continuous process. When the polymerization is carried out as a batch process, the afore-mentioned catalyst components are used in the concentrations described below.

The component (A) in the polymerization of an olefin using the above-described catalyst for polymerization of an olefin is used in the amount in the range of usually 10⁻⁹ to 10⁻¹ mmol/liter, preferably 10⁻⁸ to 10⁻² mmol/liter.

The component (b-1) is used in the amount in the range of usually 0.01 to 5,000, preferably 0.05 to 2,000, as a mole ratio of all transition metal atoms (M) in the component (b-1) to the component (A) [(b-1)/M]. The component (b-2) is used in the amount in the range of usually 0.01 to 5,000, preferably 1 to 2,000, as a mole ratio of the ionic compounds in the components (b-2) to all transition metals (M) in the component of (A) [(b-2)/M]. The component (b-3) is used in the amount in the range of usually 1 to 10000, preferably 1 to 5000, as a mole ratio of the component (b-3) to the transition metal atoms (M) in the component (A) [(b-3)/M].

The polymerization reaction is carried out under the conditions of a temperature of usually −20 to +200° C., preferably 50 to 180° C., more preferably 70 to 180° C., and a pressure of more than 0 and not more than 7.8 MPa (80 kgf/cm², gauge pressure), preferably more than 0 and not more than 4.9 MPa (50 kgf/cm², gauge pressure).

In the polymerization, the amounts of ethylene and, if desired, an α-olefin fed into the polymerization system are selected to obtain the wax having the specified composition. At this time, further, a molecular weight modifier such as hydrogen can be added.

When polymerization is carried out in this manner, a polymer produced is usually obtained as a polymerization solution containing the polymer. Therefore, by treating the polymerization solution in the usual way, a polyethylene wax is obtained.

As the metallocene catalyst, a catalyst containing the metallocene compound described in “Example 6 of metallocene compound” is preferable.

Using these catalysts, a polyolefin wax (B) having the above ranges of Mn, Mw/Mn, a melting point and other preferable physical properties can be obtained. The polyolefin wax (B) obtained with the catalysts has high effect for improving the fluidity, greatly improves the molding rate, and reduces the content of the tacky components, and thus a molded product with no surface tackiness can be obtained.

If as the thermoplastic resin (A), polyolefin, preferably, a low-density polyethylene, a medium-density polyethylene, a high-density polyethylene, a straight chained low-density polyethylene, polypropylene, and an ethylene-propylene copolymer, and more preferably high-density polyethylene, and polypropylene are used, the dispersity with the thermoplastic resin (A) and the polyolefin wax (B) gets better, the effect of improving the fluidity is increased, the molding rate can be further greatly improved, and thus a molded product with little surface tackiness can be obtained.

The amount of thus obtained polyolefin wax (B) to be blended is in the range of usually 0.01 to 20 parts by weight, preferably 0.1 to 10 parts by weight, and more preferably 0.3 to 5 parts by weight, based on 100 parts by weight of the thermoplastic resin (A).

With the blending the polyolefin wax (B) in an amount within the above range, the effect of improving the fluidity is increased, and the molding rate is also greatly improved. Further, the molding can be effected at a low molding temperature, thus leading to a reduced cooling time, and an improved molding cycle, as well as to suppression of thermal deterioration of the resin, and thus suppression of reduction in the rigidity of the resin and of burning or black speck of the resin.

[Additive]

In the present invention, if desired, stabilizers such as an antioxidant, an ultraviolet absorber, and a light stabilizer, and additives such as a metallic soap, a filler, and a flame retardant can be added to the mixture of the thermoplastic resin (A) and the polyolefin wax (B) prior to blow molding.

Examples of the stabilizer include an antioxidant such as hindered phenol compounds, phosphite compounds, and thioether compounds;

a UV absorber such as benzotriazole compounds, and benzophenone compound; and

a light stabilizer such as hindered amine compounds.

Examples of the metallic soap include stearates such as magnesium stearate, calcium stearate, and zinc stearate.

Examples of the filler include calcium carbonate, titanium oxide, barium sulfate, talc, clay and carbon black.

Examples of the flame retardant include halogenated diphenyl ether such as decabromodiphenyl ether, and octabromodiphenyl;

inorganic compounds such as antimony trioxide, antimony tetraoxide, antimony pentoxide, sodium pyroantimonate, and aluminum hydroxide; and

phosphorus compounds.

Further, as the flame retarding aid for drip prevention, a compound such as tetrafluoroethylene can be added.

Examples of the antibacterial agent or the antifungal agent include compounds such as an imidazole compound, thiazole compound, a nitrile compound, a haloalkyl compound, and a pyridine compound;

inorganics such as silver, a silver compound, a zinc compound, a copper compound, and a titanium compound; and

inorganic compounds.

Among these compounds, silver and the silver compound are desirable due to its high thermal stability.

Examples of the silver compound include silver chelate and silver salts such as fatty acid salts and phosphoric acid salts and the like.

If silver and the silver compound are used as an antibacterial agent or an antifungal agent, these may be used as supported on a porous structure such as zeolite, silica gel, zirconium phosphate, calcium phosphate, hydrotalcite, hydroxyapatite, calcium silicate.

Examples of other additives include a colorant, a plasticizer, an anti-aging agent, and oils.

[Blow Molding]

The molded product of the present invention can be obtained by melting a mixture of a thermoplastic resin (A) and a polyolefin wax (B), and blow molding the mixture.

Examples of the blow molding process include extrusion blow molding, injection blow molding, and the like.

For example, if the molded product of the present invention is obtained by extrusion blow molding, a molded product is obtained usually by melting the mixture of the thermoplastic resin (A) and the polyolefin wax (B); extruding the mixture to a tubular parison from a die at a resin temperature in the range of usually 170 to 240° C.; holding the parison in the mold having a desired shape; blowing air; and providing a mold usually at a resin temperature in the range of 160 to 230° C. Further, drawing can be effected at a ratio suitable for extrusion blow molding.

If extrusion blow molding is effected using a high-density polyethylene as the thermoplastic resin (A), a molded product is obtained by extruding the resin from a die at a resin temperature in the range of usually 170 to 220° C., preferably 180 to 210° C., and providing a mold at a resin temperature in the range of usually 160 to 210° C., preferably 170 to 200° C. Further, drawing can be effected extrusion upon blow molding.

If extrusion blow molding is effected using polypropylene as the thermoplastic resin (A), a molded product is obtained by extruding the resin from a die at a resin temperature in the range of usually 190 to 230° C., preferably 200 to 220° C., and providing a mold at a resin temperature in the range of usually 180 to 220, preferably 190 to 210° C. Further, drawing can be effected upon extrusion blow molding.

Each of these blow molding processes can be carried out using a molding machine corresponding to each blow molding process.

According to the present invention, a molded product is obtained by blow molding under the above-described condition, and by the production process of the present invention, as compared with the case of blow molding of the mixture of the thermoplastic resin (A) including no polyolefin wax (B), the physical properties of the molded product obtained by carrying out the molding at a condition of a temperature of usually 0 to 30° C. or less, preferably 10 to 20° C. or less are not deteriorated, and also a molded product can be produced with good productivity.

As such, for example, molded products which can be used for bottles for cosmetics, bottles for detergents, bottles for bath detergent, bottles for chemicals, drums, tanks, architectural materials such as external walls, automobile parts such as automobile exterior parts, industrial machinery parts, and electric and electronic parts are obtained.

### EXAMPLES

The present invention is further described with reference to the following examples, but it should be construed that the invention is in no way limited to those examples.

### Examples 1 and 2

To a Prime Polypro B221WA (MI=0.5 g/10 min.; 230° C., 2.16 kgf, density: 910 kg/m³, manufactured by Prime Polymer Co., Ltd.), a metallocene PE wax (Excerex (Registered Trademark) 30200 BT, manufactured by Mitsui Chemical Inc., content of ethylene: 95 mol %, density: 913 kg/m³, average molecular weight (Mn)=2000 in terms of polyethylene, (Mw)=5000 in terms of polyethylene, crystallization temperature (Tc)=86° C.) was added in the proportions as shown in Table 1, and then sufficiently mixed in a tumbler mixer to prepare a mixture of the polyolefin resin. The mixture of the polyolefin resin was subject to blow molding at a molding temperature of 180° C. to prepare a molded bottle having an inner volume of 1500 mL, which was evaluated.

Molding condition:

Molding machine: JEB-15 blow molding machine, manufactured by The Japan Steel Works, Ltd.
1 Parison-2 mold mode

Mold temperature: 25° C.

Blowing-air pressure: 0.5 MPa

Weight of product: 80±2.5 g

In addition, the physical properties are measured in the following manner.

[Appearance]

The appearance of the bottle was observed with eyes, and evaluated.

∘: Thickness is uniform.

Δ: Thickness non-uniformity is prominent.

x: Thickness non-uniformity is considerably prominent.

[Full-filling Capacity]

Water was poured up to the opening of the molded bottle, and the bottle was weighed.

[Dropping Strength]

800 mL of water was poured into a bottle, and the bottle was dropped from a height of 1.2 m. At this time, the number of the bottles whitened or cracked were determined to evaluate the dropping strength of the bottle.

[Number of Shots]

The number of shots was determined from the number of the bottles prepared within 1 hour.

[Molding Cycle]

The molding cycle was determined from the time taken for the preparation of one bottle.

The results of evaluation are shown in Table 1.

### Comparative Example 1

Blow molding was carried out in the same manner as in Example 1, except that the metallocene PE wax used in Example 1 was not added, and the molding temperature was changed from 180° C. to 200° C. to prepared a bottle having an inner volume of 1500 mL. The results of evaluation are shown in Table 1.

### Comparative Example 2

Blow molding was carried out in the same manner as in Example 1, except that the metallocene PE wax used in Example 1 was not added to prepared a bottle having an inner volume of 1500 mL. The results of evaluation are shown in Table 1.

TABLE 1

| | Example | Example | Comp. Ex | Comp. Ex. |
|---|---|---|---|---|
| | 1 | 2 | 1 | 2 |
| B221WA (parts) | 100 | 100 | 100 | 100 |
| Excerex (parts) | 2 | 3 | 0 | 0 |
| Molding | 180 | 180 | 200 | 180 |
| temperature | | | | |
| Weight | 80.7 | 81.3 | 79.6 | 78.2 |
| Appearance | ◯ | ◯ | ◯ | X |
| Full-filling | 1674 | 1674 | 1673 | 1669 |
| capacity | | | | |
| Dropping strength | 0 | 0 | 0 | 7 |
| (bottle/10 | | | | |
| bottles) | | | | |
| Number of shots | 259 | 264 | 202 | 174 |
| (shots/h) | | | | |
| Molding cycle (s) | 28 | 27 | 36 | 41 |

As clearly shown in Table 1, according to the present invention, even when the molding temperature is lowered from 200° C. to 180° C., the appearance and the dropping strength are not deteriorated, as well as the molding cycle is improved. Further, when the molding temperature is lowered from 200° C. to 180° C. without addition of a polyolefin wax, the appearance and the dropping strength are deteriorated, as well as the molding cycle is longer, thus the productivity being poor.

### Examples 3 to 4

To Hi-Zex 5100B (MI=0.27 g/10 min.; 190° C. N, density: 944 kg/M³; and manufactured by Prime Polymer Co., Ltd.), which is a polyethylene resin, a metallocene PE wax (Excerex (Registered Trademark) 40800 BT, manufactured by Mitsui Chemical Inc., content of ethylene: 95 mol %, density: 980 kg/m³, average molecular weight (Mn)=2200 in terms of polyethylene, (Mw)=7000 in terms of polyethylene, crystallization temperature (Tc)=116° C.) was added in the proportions as shown in Table 2, and then sufficiently mixed in a tumbler mixer to prepare a mixture of the polyolefin resins. The mixture of the polyolefin resins was subject to blow molding to prepare a bottle having an inner volume of 1000 mL.

Molding condition:

Molding machine: 3B50 hollow molding machine, manufactured by Placo Co., Ltd.
1 Parison-2 mold mode

Mold temperature: 25° C.

Blowing-air pressure: 0.5 MPa

Weight of product: 67±2 g

In addition, the physical properties are measured in the following manner.

[Appearance]

The appearance of the bottle was observed with eyes, and evaluated.

∘: Thickness is uniform.

Δ: Thickness non-uniformity is prominent.

x: Thickness non-uniformity is considerably prominent.

[Full-filling Capacity]

Water was poured up to the opening of the molded bottle, and the bottle was weighed.

[Dropping Strength]

600 mL of water was poured into a bottle, and the bottle was dropped from a height of 1.2 m. At this time, the number of the bottles cracked were determined to evaluate the dropping strength of the bottle.

[Number of Shots]

The number of shots was determined from the number of the bottles prepared within 1 hour.

[Molding Cycle]

The molding cycle was determined from the time taken for the preparation of one bottle. The results of evaluation are shown in Table 2.

### Comparative Example 3

Blow molding was carried out in the same manner as in Example 3, except that the metallocene PE wax used in Example 3 was not added, and the molding temperature was changed from 150° C. to 170° C. to prepared a bottle having an inner volume of 1000 mL. The results of evaluation are shown in Table 1.

### Comparative Example 4

Blow molding was carried out in the same manner as in Example 3, except that the metallocene PE wax used in Example 3 was not added to prepared a bottle having an inner volume of 1000 mL. The results of evaluation are shown in Table 1.

TABLE 2

| | Example | Example | Comp. Ex. | Comp. Ex. |
|---|---|---|---|---|
| | 3 | 4 | 3 | 4 |
| 5100B (parts) | 100 | 100 | 100 | 100 |
| Excerex (parts) | 2 | 3 | 0 | 0 |
| Molding | 150 | 150 | 170 | 150 |
| temperature | | | | |
| Weight | 67.3 | 67.6 | 66.8 | 65.7 |
| Appearance | ◯ | ◯ | ◯ | X |
| Full-filling | 1131 | 1131 | 1130 | 1126 |
| capacity | | | | |
| Dropping strength | 0 | 0 | 0 | 9 |
| (bottle/10 | | | | |
| bottles) | | | | |
| Number of shots | 149 | 151 | 113 | 93 |
| (shots/h) | | | | |
| Molding cycle (s) | 24 | 24 | 32 | 39 |

As clearly shown in Table 2, according to the present invention, even when the molding temperature is lowered from 170° C. to 150° C., the appearance and the dropping strength are not deteriorated, as well as the molding cycle is improved. Further, when the molding temperature is lowered from 170° C. to 150° C. without addition of a polyolefin wax, the appearance and the dropping strength are deteriorated, as well as the molding cycle is longer, thus the productivity being poor.

What is claimed is:

1. A process for producing a molded product, comprising melting a mixture of a thermoplastic resin (A) and a polyolefin wax (B) which has a number-average molecular weight (Mn) in terms of polyethylene, in the range of 200 to 5,000, and a crystallization temperature, as measured by a differential scanning calorimetry (DSC) under the condition of a temperature lowering rate of 2° C./min., in the range of 65 to 120° C., and then subjecting the mixture to blow molding.

2. A process for producing a molded product, comprising melting a mixture of a thermoplastic resin (A) and a polyolefin wax (B) which has a number-average molecular weight (Mn) in terms of polystyrene, in the range of 400 to 5,000, and a crystallization temperature, as measured by a differential scanning calorimetry (DSC) under the condition of a temperature lowering rate of 2° C./min., in the range of 65 to 120° C., and then subjecting the mixture to blow molding.

3. The process according to claim 1, wherein the polyolefin wax (B) is a polyethylene wax.

4. The process according to claim 1, wherein the polyolefin wax (B) is obtained by using a metallocene catalyst.
